(19) United States
(12) Patent Application Publication
(10) Pub. No.: US 2024/0096108 A1
(43) Pub. Date: Mar. 21, 2024

(54) METHOD FOR THE EARLY RECOGNITION OF A STOPPING POSITION FOR A DRIVER ASSISTANCE SYSTEM

(71) Applicant: Robert Bosch GmbH, Stuttgart (DE)

(72) Inventors: Jose Domingo Esparza Garcia, Stuttgart (DE); Max Neuner, Boeblingen (DE); Patrick Koegel, Ludwigsburg (DE); Peter Golya, Budapest (HU); Wenhuan Duan, Suzhou (CN)

(21) Appl. No.: 18/448,401

(22) Filed: Aug. 11, 2023

(30) Foreign Application Priority Data
Sep. 16, 2022 (CN) 2022 1 1129288.3

(51) Int. Cl. G06V 20/58; G06V 20/56

(52) U.S. Cl. CPC G06V 20/584; G06V 20/588; B60W 30/181

(57) ABSTRACT

A method for the early recognition of a stopping position for a driver assistance system of an ego vehicle at a stop signal by a light signal system. An enlarged working area and increased possible speeds are achieved in that a stop signal of a light signal system for an ego roadway of the ego vehicle is recognized; if a stop signal is recognized, the ego roadway is searched for a crosswalk, wherein if a crosswalk is recognized, the crosswalk is used for the early recognition of a stopping position of the ego vehicle. A computer program product for performing the method and a motor vehicle performing the method are also described.

### CROSS REFERENCE

The present application claims the benefit under 35 U.S.C. § 119 of China Patent Application No. CN 2022 1 1129288.3 filed on Sep. 16, 2022, which is expressly incorporated herein by reference in its entirety.

### FIELD

The present invention relates to a method for the early recognition of a stopping position for a driver assistance system of an ego vehicle at a stop signal by a light signal system. The present invention furthermore relates to a computer program product for performing the method and to a motor vehicle performing the method.

A driver assistance system in a motor vehicle serves the purpose of assisting a vehicle driver in guiding the motor vehicle or at least partially taking over the guidance of the motor vehicle. For this purpose, a driver assistance system requires information about the environment of the motor vehicle, which is hereinafter also referred to as the ego vehicle. This information generally includes information about the traffic situation.

Such a traffic situation comprises a light signal system, e.g., a traffic light, which emits a stop signal for the roadway on which the ego vehicle is traveling, hereinafter also referred to as the ego roadway. In such a case, in addition to recognizing the stop signal, a position at which the ego vehicle should stop due to the stop signal, hereinafter also referred to as the stopping position, is also of interest.

The present invention relates to an object of specifying improved or at least other embodiments, which eliminate disadvantages from the related art, for a method for the early recognition of a stopping position of the type described, for a computer program product for performing the method, and for a motor vehicle performing the method. In particular, the present invention relates to an object of specifying improved or other embodiments, which are characterized by an enlarged working area and/or increased possible speeds, for the method, for the computer program product, and for the motor vehicle.

This object may be achieved by features of the present invention. Advantageous embodiments of the present invention are disclosed herein.

Accordingly, the present invention is based on using an associated crosswalk for the early recognition of a stopping position for a driver assistance system of an ego vehicle at a stop signal by a light signal system and of using the area of the crosswalk for the early recognition of the stopping position. In comparison to a stop line on a roadway, a crosswalk has a longer extension along the roadway and a plurality of stripes so that the crosswalk can be recognized both in a simplified and reliable manner and from a greater distance than the stop line, which typically extends transversely to the roadway. As a result, the stopping position can be recognized earlier and from a greater distance than in the case of the recognition of a stop line. As a result, the area of the recognition of the stopping position is enlarged. This results in an enlarged working area. In addition, in the case of a stop signal, this enables increased speeds and/or increases the reliability of the driver assistance system.

According to the present invention, in the method for the early recognition of a stopping position for a driver assistance system of an ego vehicle at a stop signal by a light signal system, a stop signal of a light signal system is recognized for the roadway on which the ego vehicle travels, hereinafter also referred to as an ego roadway. That is to say, it is recognized whether there is an associated stop signal for the ego roadway. If such a stop signal is recognized, the ego roadway is searched for a crosswalk. If a crosswalk is recognized, the crosswalk is used for the early recognition of a stopping position of the ego vehicle.

The stopping position is the position at which the ego vehicle will subsequently stop due to the associated stop signal. The stopping position can therefore also be referred to as the target stopping position.

The crosswalk is expediently arranged in front of the associated light signal system.

The light signal system can be of any type that generates and emits a stop signal for the ego roadway.

The light signal system is generally a traffic light. In the case of the traffic light, the stop signal is generally indicated in color, usually round.

In the present case, a driver assistance system is to be understood as a system that is designed to assist a vehicle driver and/or to at least partially autonomously drive the ego vehicle.

According to an example embodiment of the present invention, the recognition of the crosswalk advantageously comprises the recognition of lines on the ego roadway that run along the ego roadway and are spaced apart from one another transversely to the ego roadway. That is to say, in advantageous variants, lines that run along the ego roadway and are spaced apart from one another transversely to the ego roadway are recognized as a crosswalk. This results in simple and reliable recognition of crosswalks from greater distances.

Using the crosswalk for the early recognition of the stopping position may mean that the crosswalk, preferably a fictitious line at a predetermined distance from the crosswalk, is determined as the stopping position.

In advantageous embodiments of the present invention, further indications on the ego roadway are used to determine the stopping position.

These indications advantageously include a stop line associated with the light signal system and with the ego roadway. That is to say, the ego roadway is furthermore searched for a stop line. If a stop line becomes known, the stop line can be determined as the stopping position. In this variant, the crosswalk is used for the early recognition so that the information on the upcoming stop and in particular on the area of the stopping position is available to the driver assistance system earlier. The exact stopping position is thus preferably determined by recognizing the stop line during the approach of the crosswalk. In other words, when the stop line is recognized, the stopping position is updated to the stop line. Since the stop line can only be reliably and accurately recognized from a short distance in comparison to the crosswalk, the driver assistance system can thus guide the ego vehicle more reliably or assist the vehicle driver more reliably. It is also possible for the ego vehicle to drive to the stop line at an increased speed since an area for stopping the ego vehicle is already known with the crosswalk. In particular, both the working area and the reliability of the method are thus increased.

The stop line associated with the light signal system and with the ego roadway is expediently arranged in front of the crosswalk, furthermore expediently arranged in front of the light signal system. The stop line in particular runs transversely to the ego roadway.

According to an example embodiment of the present invention, if no stop line is recognized, the crosswalk, preferably a fictitious line at a predetermined distance from the crosswalk, is preferably determined as the stopping position. That is to say, the ego roadway is furthermore searched for a stop line. In the case no stop line is recognized, the crosswalk or the fictitious line at the predetermined distance from the crosswalk is determined as the stopping position.

Alternatively or additionally, such an indication is an arrow on the ego roadway that points along the ego roadway. Embodiments in which the ego roadway is furthermore searched for arrows are thus preferred. If an arrow pointing along the ego roadway is recognized, an area between the arrow tip and the crosswalk is used for the early recognition of the stopping position of the ego vehicle. In particular, it is possible to determine the area as a stopping position, in particular if no stop line is recognized.

The recognition of the stop signal, of the crosswalk, of the stop line and of the arrow can in each case take place in any way.

In preferred embodiments of the present invention, the recognition of stop signals and crosswalks, preferably furthermore of stop lines and/or arrows, takes place by means of a camera system, which comprises at least one camera, of the motor vehicle. That is to say, the recognition takes place by analyzing the images captured by means of the camera system. This results in a simplified implementation of the method as well as reliable recognition of the stop signals and of the crosswalks, preferably also of stop lines and/or arrows. Accordingly, the method is thus simplified and reliable.

In principle, it is possible to permanently search the ego roadway for crosswalks in order to determine the stopping position associated with the stop signal.

In preferred embodiments of the present invention, crosswalks are used to determine the stopping position only if a stop signal has previously been recognized. This results in increased reliability of the method.

According to an example embodiment of the present invention, the method is preferably performed by means of a computer program product. The computer program product is thus designed to perform the method.

The computer program product advantageously contains instructions that are readable by a computer system, in such a way that, when the computer program product is executed, the computer system performs the method.

The computer program product is advantageously stored on a storage system comprising at least one non-volatile memory.

It is understood that the computer program product is also part of the scope of the present invention.

It is furthermore understood that a motor vehicle in which the method is performed, in particular by means of the computer program product, is likewise part of the scope of the present invention.

The motor vehicle, and thus the ego vehicle, comprises a driver assistance system. Moreover, according to an example embodiment of the present invention, the ego vehicle comprises a control unit which is designed to perform the method and is communicatively connected to the driver assistance system in such a way that the control unit provides the stopping position to the driver assistance system.

The ego vehicle furthermore advantageously comprises a camera system, which comprises at least one camera, captures the environment of the ego vehicle during operation and provides the captured images to the control unit. Accordingly, the control unit is communicatively connected to the camera system.

Further important features and advantages of the present invention become apparent from the figures, and the accompanying figure description in reference to the figures.

It is understood that the aforementioned features and the features yet to be explained below can be used not only in the respectively specified combination but also in other combinations, or alone, without departing from the scope of the present invention.

Preferred embodiments of the present invention are illustrated in the figures and explained in greater detail in the description below, wherein identical reference signs refer to identical or similar or functionally identical components.

### BRIEF DESCRIPTION OF THE DRAWINGS

FIG. 1 schematically shows a highly simplified plan view of an ego vehicle, according to an example embodiment of the present invention.

FIG. 2 shows a flow chart for the early recognition of a stopping position at a stop signal of a light signal system, according to an example embodiment of the present invention.

FIG. 3 shows a traffic situation from the perspective of the ego vehicle.

FIG. 4 shows another traffic situation from the perspective of the ego vehicle.

### DETAILED DESCRIPTION OF EXAMPLE EMBODIMENTS

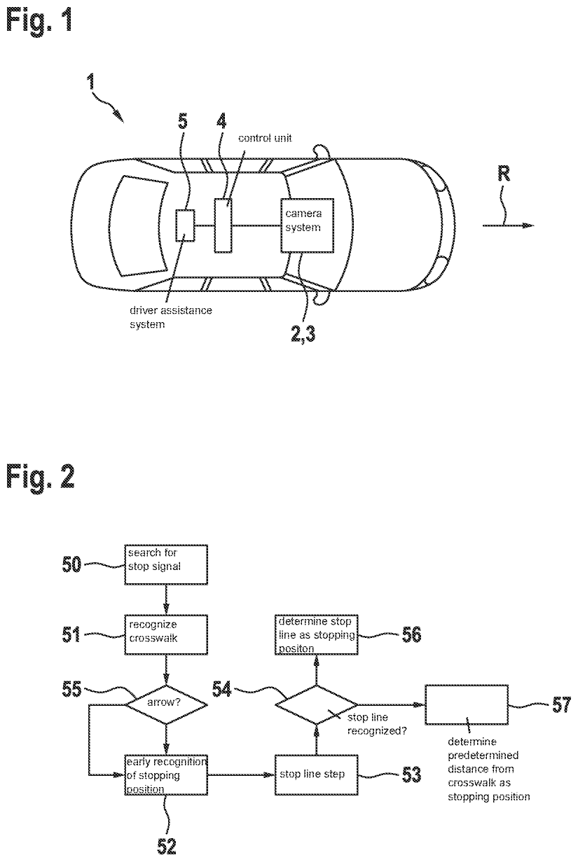

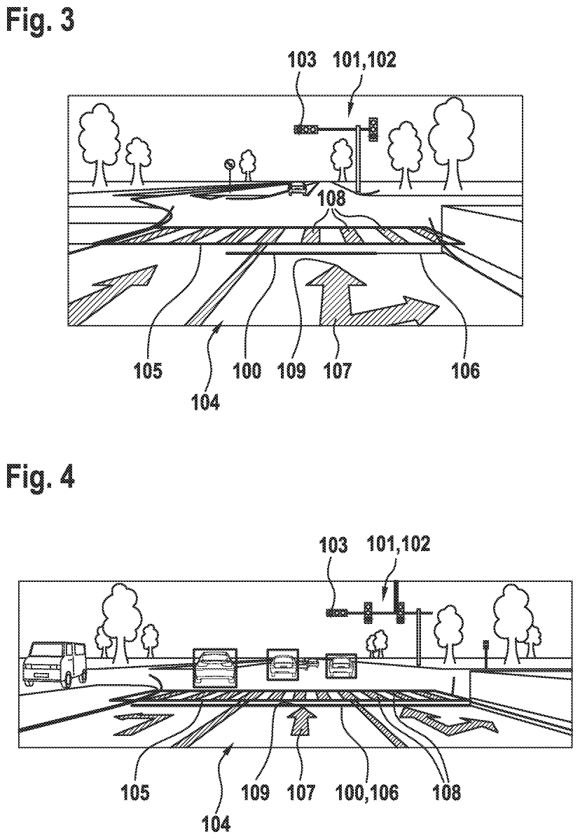

A motor vehicle 1, as is shown in FIG. 1 in a highly simplified, circuit-diagram-like plan view, comprises a driver assistance system 5 for assisting a vehicle driver (not shown) and/or for at least partially autonomous driving of the motor vehicle 1. For this purpose, the driver assistance system 5 requires information on the environment of the motor vehicle 1. In the exemplary embodiment shown, the motor vehicle 1, which is hereinafter also referred to as the ego vehicle 1, comprises for this purpose a camera system 2 which, purely by way of example, comprises a single camera 3 in the exemplary embodiment shown. The images captured by means of the camera system 2 each reflect a traffic situation (cf. FIGS. 3 and 4) from the perspective of the ego vehicle 1. FIGS. 3 and 4 show 2 such images, wherein a traffic situation in the direction of travel R of the ego vehicle 1 can in each case be seen.

The method described below with reference to the flow chart shown in FIG. 2 is used for the early recognition of a stopping position 100 (see FIGS. 3 and 4) for the driver assistance system 5 of the ego vehicle 1 at a stop signal 103 by a light signal system 101 (see FIGS. 3 and 4). In so doing, for a roadway 104 (shown in FIGS. 3 and 4) on which the ego vehicle 1 travels, an associated stop signal 103 of a light signal system 101 is recognized. The roadway 104 is hereinafter also referred to as the ego roadway 104. If a stop signal 103 is recognized, the ego roadway 104 is searched for a crosswalk 105. If a crosswalk 105 is recognized, the crosswalk 105 is used for the early recognition of the stopping position 100 of the ego vehicle 1.

According to FIG. 2, in a method step 50, a stop signal 103 associated with the ego roadway 104 is searched for in the images (see FIGS. 3 and 4). In the examples shown in FIGS. 3 and 4, the light signal system 101 is a traffic light 102. The method step 50 is hereinafter also referred to as the stop signal step 50. If a stop signal 103 associated with the ego roadway 104 becomes known, the ego roadway 103 is searched for a crosswalk 105 (see FIGS. 3 and 4) in a subsequent method step 51, wherein the crosswalk 105 is expediently arranged in front of the stop signal 103. The method step 51 is hereinafter also referred to as the crosswalk step 51. In the crosswalk step 51 in the exemplary embodiment shown, lines 108 on the ego roadway 104 that run along the ego roadway 104 and are spaced apart from one another transversely to the ego roadway 104 are recognized as a crosswalk 105. Furthermore, in the exemplary embodiment shown, the ego roadway 104 is searched during the approach of the stop signal 103 for a crosswalk 105 for the early recognition of the stopping position 100 only if a stop signal 103 is recognized. If a crosswalk 105 is recognized in the crosswalk step 51, the crosswalk 105 is used in a method step 52 for the early recognition of the stopping position 100. The method step 52 is hereinafter also referred to as the early recognition step 52.

In the exemplary embodiment shown, in addition to the crosswalk 105, further indications on the ego roadway 104 are considered. As can be seen in FIGS. 2 to 4, in a method step 53, the ego roadway 104 is searched for a stop line 106 associated with the ego roadway 104 and with the associated stop signal 103 and arranged in front of the crosswalk 105. The method step 53 is hereinafter also referred to as the stop line step 53. The stop line 106 runs transversely to the ego roadway 104. The result of the stop line step 53 is provided to a subsequent method step 54 in which a stopping position 100 is determined depending on the result. The method step 54 is hereinafter also referred to as the stopping position determination step 54. If an associated stop line 106 is recognized, the stop line 106 is determined as the stopping position 100 in the stopping position determination step 54. This is indicated in FIG. 2 with a separate box 56. In contrast, if no associated stop line 106 is recognized, the crosswalk 105, preferably a fictitious line (not shown) at a predetermined distance from the crosswalk 105, is determined as the stopping position 100 in the stopping position determination step 54. This is indicated in FIG. 2 with a separate box 57.

As shown in FIG. 2, in the exemplary embodiment shown, arrows 107 on the ego roadway 104 (cf. FIGS. 3 and 4) are also taken into account as an indication in addition to the crosswalk 105, as an alternative or in addition to the stop line 106, preferably in addition to the stop line 106. In the exemplary embodiment shown in FIG. 2, this takes place in a method step 55, which is hereinafter also referred to as the arrow recognition step 55, after the crosswalk step 51 and before the early recognition step 52. In the arrow recognition step 55, the ego roadway 104 is searched for arrows 107. If an arrow 107 pointing along the ego roadway 104 is recognized, an area between the arrow tip 109 of the arrow 107 and the crosswalk 105 is used for the early recognition of the stopping position 100 of the ego vehicle 1. In this case, if the stop line 106 is absent, the stopping position determination step 54 determines the area between the crosswalk 105 and the arrow tip 109 as the stopping position 100 (box 57). In contrast, if no such arrow 107 is recognized, only the crosswalk 105 is used for the early recognition of the stopping position 100.

The result of the method, i.e., both the early recognition of the stopping position 100 and the determination of the stopping position 100, are provided to the driver assistance system 5.

The method can be performed with a correspondingly equipped computer program product.

In the exemplary embodiment shown, the ego vehicle 1, as can be seen in FIG. 1, comprises a correspondingly equipped control unit 4 for performing the method. In particular, the control unit 4 can at least partially contain and/or perform the computer program product. Accordingly, the control unit 4 is communicatively connected to the camera system 2 and the driver assistance system 5.

What is claimed is:

1. A method for early recognition of a stopping position for a driver assistance system of an ego vehicle at a stop signal by a light signal system, the method comprising the following steps:
recognizing the stop signal of the light signal system for an ego roadway of the ego vehicle;
based on recognizing the stop signal, searching the ego roadway for a crosswalk; and
based on recognizing the crosswalk, using the crosswalk for the early recognition of the stopping position of the ego vehicle.

2. The method according to claim 1, further comprising:
searching the ego roadway for a stop line; and
based on recognizing the stop line, determining the stop line as the stopping position.

3. The method according to claim 2, wherein the ego roadway is searched for the stop line in front of the crosswalk.

4. The method according to claim 1, further comprising:
searching the ego roadway for a stop line;
based on the stop line being absent, determining the crosswalk or a fictitious line at a predetermined distance from the crosswalk as the stopping position.

5. The method according to claim 4, wherein the stop signal and the crosswalk are recognized using a camera system of the ego vehicle.

6. The method according to claim 1, wherein lines on the roadway that run along the ego roadway and are spaced apart from one another transversely to the ego roadway are recognized as the crosswalk.

7. The method according to claim 1, further comprising:
searching the ego roadway for arrows;
based on recognizing an arrow pointing along the ego roadway, an area between an arrow tip and the crosswalk is used for the early recognition of the stopping position of the ego vehicle.

8. The method according to claim 1, further comprising:
based on recognizing the stop signal, searching the ego roadway for the crosswalk during an approach of the stop signal.

9. A non-transitory computer-readable medium on which is stored a computer program for early recognition of a stopping position for a driver assistance system of an ego vehicle at a stop signal by a light signal system, the computer program, the executed by a computer, causing the computer to perform the following steps:
recognizing the stop signal of the light signal system for an ego roadway of the ego vehicle;
based on recognizing the stop signal, searching the ego roadway for a crosswalk; and
based on recognizing the crosswalk, using the crosswalk for the early recognition of the stopping position of the ego vehicle.

10. A motor vehicle, comprising:
a driver assistance system;
a camera system, includes at least one camera, configured to monitor an environment of the motor vehicle; and
a control unit which communicates with the camera system and the driver assistance system, the control unit configured for early recognition of a stopping position for a driver assistance system of the vehicle at a stop signal by a light signal system, the control unit configured to:
recognize the stop signal of the light signal system for an ego roadway of the vehicle,
based on recognizing the stop signal, searching the ego roadway for a crosswalk,
based on recognizing the crosswalk, using the crosswalk for the early recognition of the stopping position of the vehicle, and
provide the stopping position to the driver assistance system.
